(19) United States
(12) Patent Application Publication
(10) Pub. No.: US 2010/0070591 A1
(43) Pub. Date: Mar. 18, 2010

(54) ADDRESS REPLACEMENT IN ELECTRONIC COMMUNICATION

(76) Inventors: Michael Samuel Steuer, Los Angeles, CA (US); David Ryan Waldman, Santa Monica, CA (US); Gustavo De Greiff, Santa Monica, CA (US)

Correspondence Address: Michael Samuel Steuer, 11406 Missouri Ave., Los Angeles, CA, 90025, US

(21) Appl. No.: 12/212,683

(22) Filed: Sep. 18, 2008

(51) Int. Cl. G06F 15/16

(52) U.S. Cl. 709/206

(57) ABSTRACT

Methods and apparatus for communication by electronic mail have been provided, for example, communication from a blind copy recipient responding to an email while protecting the identity or existence of the Bcc recipient. An embodiment of the invention is a method of communicating by electronic mail. The method comprises the steps of forming a first original electronic mail by an originator, replacing a second recipient address associated with a second recipient with a third recipient address associated with a third recipient, sending the original electronic mail to a first recipient, and forwarding, by the third recipient, a first electronic mail to the second recipient.

### CROSS REFERENCE TO RELATED PATENT APPLICATIONS

The present application is related to the U.S. patent application identified as Attorney Docket No. 31908DSW-1 entitled “Method And Apparatus For Electronic Communication,” filed concurrently herewith, the disclosure of which is incorporated by reference herein.

The present application is related to the U.S. patent application identified as Attorney Docket No. 31908DSW-3 entitled “Receiving Email within an Email Thread,” filed concurrently herewith, the disclosure of which is incorporated by reference herein.

### FIELD OF THE INVENTION

This invention relates generally to the formation of electronic mail. More specifically, this invention relates to protecting the identity or existence of an electronic mail recipient while enabling the recipient to reply to the electronic mail.

### BACKGROUND OF THE INVENTION

Electronic mail, for example email and text messaging is used extensively for personal and business communication. Often, email messages are sent to more than one recipient, for example one or more primary (To) recipients, one or more courtesy copy (Cc) recipients, and one or more blind copy (Bcc) recipients. It is often desired to conceal the identity or existence of one or more of the recipients, for example a Bcc recipient. However it is also often desirable for the Bcc recipient to respond to email within an email thread. Consequently, there is a need for a method of communication by electronic mail, particularly email, wherein, a Bcc recipient is able to respond to email, within an email thread, without disclosing the identity or even the existence of the Bcc recipient.

### SUMMARY OF THE INVENTION

Principles of the invention provide, for example, methods and apparatus for communication by electronic mail, and allowing email addresses in reply email to be replaced by an alternate email to direct reply email to an alternate destination.

For example, in accordance with one aspect of the invention, a method of communicating by electronic mail is provided. The method comprises the steps of forming a first original electronic mail by an originator, replacing a second recipient address associated with a second recipient with a third recipient address associated with a third recipient, sending the original electronic mail to a first recipient, and forwarding, by the third recipient, a first electronic mail to the second recipient.

An advantage of the invention is, for example, allowing a blind copy (Bcc) recipient to respond to an email while protecting the identity or existence of the Bcc recipient. Another advantage is, for example, to filter email by content, or by other criteria, before allowing intended recipients to receive the email.

These and other features, objects and advantages of the present invention will become apparent from the following detailed description of illustrative embodiments thereof, which is to be read in connection with the accompanying drawings.

### BRIEF DESCRIPTION OF THE DRAWINGS

FIG. 1 shows a first method for communication by email, according to an exemplary embodiment of the invention.

FIG. 2 shows a second method for communication by email, according to an exemplary embodiment of the invention.

FIG. 3 shows a third method for communication by email, according to an exemplary embodiment of the invention.

FIG. 4 illustrates email addresses according to an exemplary embodiment of the invention.

FIG. 5 illustrates an email composer window, according to an exemplary embodiment of the invention.

FIG. 6 illustrates a computer system in accordance with which one or more components/steps of the techniques of the invention may be implemented, according to an exemplary embodiment of the invention.

### DETAILED DESCRIPTION OF THE INVENTION

The term electronic mail, as used herein, refers to a communication, comprising text, by electronic means, for example, email and text messaging.

The term email server, as used herein, is a computer acting as a mail transfer agent (MTA), that is, the email server is running appropriate software, for example an MTA computer program. The email server, along with the appropriate software, transfers electronic mail messages from one computer to another. An MTA is also termed a mail transport agent, message transfer agent, simple mail transfer protocol (SMTP) daemon and extended or enhanced simple mail transfer protocol (ESMTP) daemon. The email server typically is coupled to a network, for example, the Web, Internet or an intranet, to facilitate email transfer.

The term client, as used herein, is a computing resource of a user, an originator, a receiver, or a responder to an email. The client is, for example, the computing resource on which the electronic mail is composed, received, or responded to. The client is, for example, a computer, a laptop, a workstation, a text messaging device, personal digital assistant, a cellular phone, a portable Web access device, a television set top box, or a public email computing resource adapted to sending and receiving email. The client may be, for example, an on-site computing resource which is in the possession of a user. Clients can be associated with other entities besides the user. Unless specified otherwise, client refers to the client of the user. The user is, for example, an originator or recipient of an email or other electronic mail.

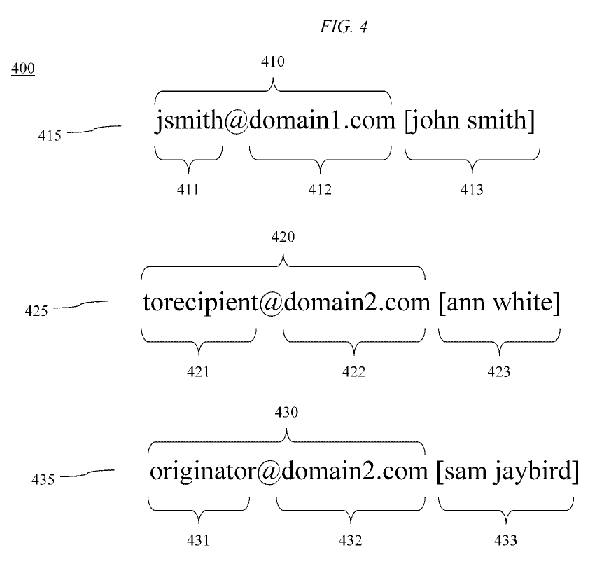

An email address identifies a location to which email messages can be delivered. Most email on the internet uses the Simple Mail Transfer Protocol (SMTP), which is defined in the internet standards RFC 2821 and RFC 2822. An email address on the Internet looks like, for example, jsmith@example.com. As an example, FIG. 4 illustrates an email address 410 comprised of two parts: a local-part 411 and a domain 412. The part before the @ sign is the local-part 411 of the address, often the username, and the part after the @ sign is the domain 412 which is typically a hostname where the email will be sent. For example, the hostname is looked up in the Domain Name System to find the mail transfer agent or Mail eXchangers (MXs) accepting email for that address.

Email may be addressed to one or more recipients, for example, recipients of three types. The types of recipients are direct (To) recipients, courtesy or carbon copy (Cc) recipients, and blind copy (Bcc) recipients. In many cases, it is desired that the identity of the Bcc recipient not be disclosed to the To and Cc recipients, or even to other Bcc recipients. The Bcc recipient responding to an email thread typically discloses that the Bcc recipient received the original email.

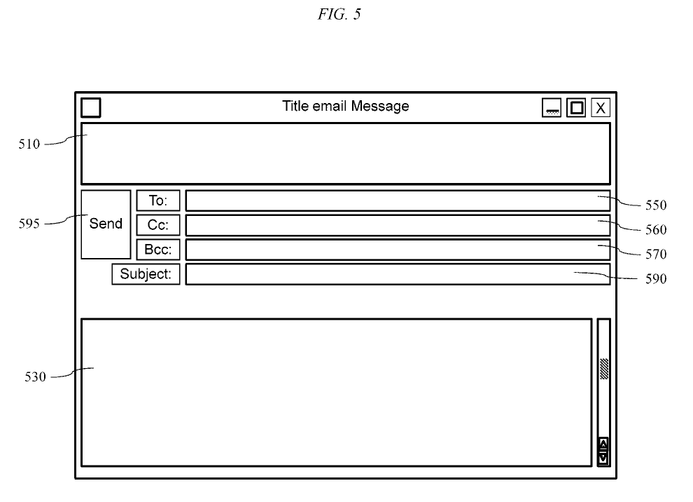

Sometimes an email address is shown in association with a name of the holder of the email address. For example, with reference to FIG. 5, within the To recipient address block 550, the Cc recipient address block 560, or the Bcc recipient address block 570, the email address may be shown along with the name of the holder. FIG. 4 illustrates an email address with name display 415 of an email address 410 shown in association with a name 413. The name 413 is not normally used to route or deliver the email, but is typically used to identify within the email composer window, the name of the email recipient associated with the email address. The association may also be, for example, contained within an address list or contact list of the composer of the email.

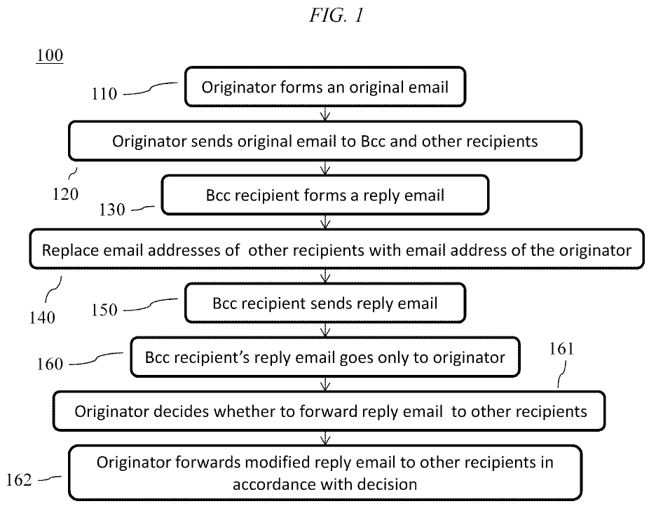

FIG. 1 shows a first method 100 of communication by email according to an embodiment of the invention. The first method 100 allows the Bcc recipient to reply to an email within an email thread without disclosing the identity of the Bcc recipient.

FIG. 1 shows the steps of the first method 100 occurring in an exemplary order. The invention is not so limited; the steps may occur in other orders.

In the first step 110, an originator forms an original email message. The email message is typically formed on a client of the originator, termed the originator client. Methods of forming an email message are known in the art. For example, the original email message may be formed within a window shown in FIG. 5.

In the second step 120, the originator sends the original email message to at least one Bcc recipient and at least one other recipient. The at least one other recipient is, for example, a To recipient, Cc recipient, another Bcc recipient, or a combination of To, Cc and other Bcc recipients. Methods of sending email messages are known in the art.

In the third step 130, the Bcc recipient forms a reply email. The reply email is in reply to the original email or another email in an email thread that comprises the original email. The email thread comprises the original email and other emails sent in response to the original email or any other email in the email thread. The Bcc recipient typically forms the reply email on a client of the Bcc recipient, termed the Bcc recipient client. The original email message may be formed, for example, within a window shown in FIG. 5. The reply email is intended, by the Bcc recipient, to be received by all the recipients of the original email, for example, all of the To, Cc and Bcc recipients of the original email, including the at least one other recipient. The reply email is addressed to the originator.

In the fourth step 140, in the reply email, the email address of the at least one other recipient are replaced by the email address of the originator. The email addresses of the at least one other recipient is replace by the email address of the originator either by a client of the originator (originator client) or by a client of the Bcc recipient (Bcc recipient client). The reply email now comprises modified email addresses, comprising only the email address of the originator, in place of the email address of the at least one other recipient. The modified email addresses have been formed so that the modified email addresses comprise the email address of the originator, in place of the email addresses of the at least one other recipient, so that the reply email will not be received by the at least one other recipient directly from the Bcc recipient forming the reply email. For example, with reference to FIG. 4, consider an original email, sent by an originator, having the name Sam Jaybird, to two recipients, a Bcc recipient, and a To recipient having the name Ann White and having a To recipient address 420. The Bcc recipient replies to the original email with a reply email that is intended to go to the originator and to the To recipient, Ann White. However, within the reply email, in order to keep secret the identity, or possibly even the existence, of the Bcc recipient, the To recipient address 420 is replaced with the originator address 430. Both the local-part 421 and the domain 422 of the To recipient address 420 are removed. The local-part 421 and the domain 422 of the To recipient address 420 is replaced by a local-part 431 and a domain 432 of an originator address 430, causing the reply email to be sent directly to the originator in place of the To recipient, Ann White. The To recipient name 423 may have been displayed in association with the To recipient address 420 prior to replacing the To recipient address 420 with the originator address 430. For example, the To recipient name 423 may have been displayed in association with the To recipient address 420 within the To recipient address blocks 550 of the reply email composer window 500. In one embodiment, the To recipient name 423 continues to be displayed in association with the To recipient address 420 after replacing the To recipient address 420 with the originator address 430. In another embodiment, the To recipient name 423 is displayed in association with the originator address 430 after replacing the To recipient address 420 with the originator address 430. In the reply email message received by the originator as a consequence of the originator address 430 replacing To recipient address 420, the To recipient name 423 may be displayed in association with the originator address 430.

In the fifth step 150, the Bcc recipient sends the reply email. Because in the fourth step 140, the email addresses of the at least one other recipient have been replaced by the email address of the originator, the reply email is only sent to the originator.

In the sixth step 160, the reply email goes only to the originator. The originator receives the reply email. The other email recipients do not directly receive the reply email from the Bcc recipient that formed the reply email.

In the seventh step 161, the originator decides whether to forward the reply email to the at least one other recipient, or not to forward the reply email to the at least one other recipient. The originator can selectively decide, that is, the originator can decide to forward the reply email to one or more of the at least one other recipient while not forwarding the reply email to one or more others of the at least one other recipient. The decision can be a real time decision, that is, the originator makes the decision for each reply email and for each of the at least one other recipient. Alternately, the decision can be a premade decision, that is, the originator has instructed the originator client to automatically forward the reply email to all or selected ones of the at least one other recipient, or alternately not to forward the reply email to all or selected ones of the at least one other recipient.

The originator client knows the identity, and therefore the true email addresses of the at least one other recipient, for example, in one of two ways. The first way is the association, within the reply email sent by the Bcc recipient, of the at least one other recipient names with the email address of the originator. The association of the at least one other recipient names with the email address of the originator was previously described with reference to FIG. 4. In this case, the names of the at least one other recipient were retained within the reply email, but the email addresses associated with the names were changed to the email address of the originator. In the second way, the names of the at least one other recipient, in association with the originator address, do not have to be retained within the reply email sent by the Bcc recipient. The originator, or the originator client, knows the names of the at least one other recipient by association with the original email. The originator, or the originator client, identifies the original email using identifying text in the reply email, for example using identifying text within the subject entry block 590 of the reply email, or by using identifying text within the message block 530 of the reply email.

In the eighth and last step 162, the originator forwards reply email to the at least one other recipient in accordance with the decision made the seventh step 161.

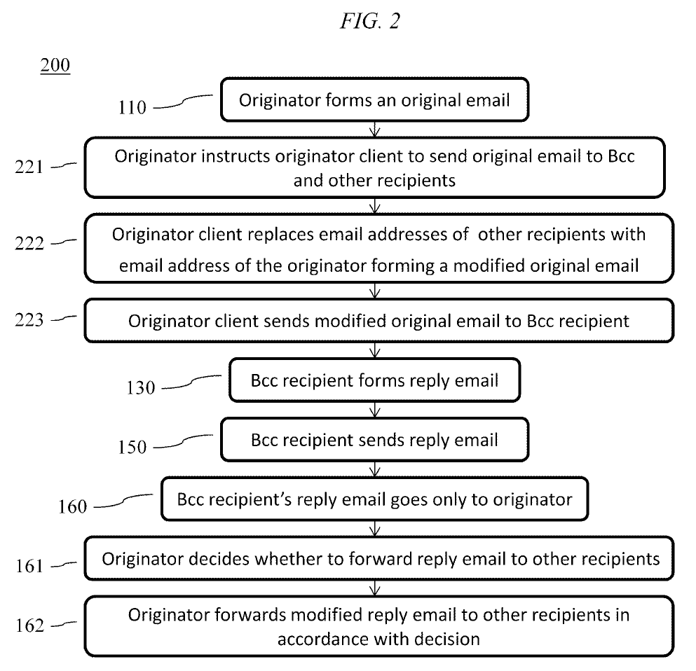

FIG. 2 shows a second method 200 of communication by email according to an alternate embodiment of the invention. The second method 200 allows the Bcc recipient to reply to an email within an email thread without disclosing the identity of the Bcc recipient.

FIG. 2 shows the steps of the second method 200 occurring in an exemplary order. The invention is not so limited; the steps may occur in other orders.

In the first step 110, an originator forms an email original email message. The email message is typically formed on a client of the originator, termed the originator client. Methods of forming an email message are known in the art. For example, the original email message may be formed within a window shown in FIG. 5.

In the second step 221, the originator instructs the originator client to send the original email message to at least one Bcc recipient and at least one other recipient. The at least one other recipient is, for example, a To recipient, Cc recipient, another Bcc recipient, or a combination of To, Cc and other Bcc recipients.

In the third step 222, the originator client replaces the email addresses of the at least one other recipient with an email address of the originator forming a modified email addresses and forming a modified original email. The modified original email comprises the modified email addresses in place of the email addresses of the at least one other recipient. The modified email addresses have been formed so that the modified email addresses comprise the email address of the originator, in place of the email addresses of the at least one other recipient, so that a subsequent reply email from the Bcc recipient will not be received by the at least one other recipient directly from the Bcc recipient. For example, with reference to FIG. 4, consider an original email, sent by an originator, having the name Sam Jaybird, to two recipients, a Bcc recipient, and a To recipient having the name Ann White and having a To recipient address 420. The Bcc recipient will reply to the original email with a subsequent reply email that is intended to go to the originator and to the To recipient, Ann White. However, within the modified original email, in order to keep secret the identity, or possibly even the existence, of the Bcc recipient, the To recipient address 420 is replaced with the originator address 430, thus forming the modified original email. Both the local-part 421 and the domain 422 of the To recipient address 420 are removed. Instead, the local-part 421 and the domain 422 of the To recipient address 420 is replaced by a local-part 431 and a domain 432 of an originator address 430, which will cause, when the Bcc recipient replies, the subsequent reply email to be sent directly to the originator in place of the To recipient, Ann White. The To recipient name 423 may have been displayed in association with the To recipient address 420 prior to replacing the To recipient address 420 with the originator address 430. For example, the To recipient name 423 may have been displayed in association with the To recipient address 420 within the To recipient address blocks 550 of the subsequent reply email composer window 500. In one embodiment, the To recipient name 423 continues to be displayed in association with the To recipient address 420 after replacing the To recipient address 420 with the originator address 430. In another embodiment, the To recipient name 423 is displayed in association with the originator address 430 after replacing the To recipient address 420 with the originator address 430. In the subsequent reply email message received by the originator as a consequence of the originator address 430 replacing To recipient address 420, the To recipient name 423 may be displayed in association with the originator address 430.

In the fourth step 223, the originator client sends the modified original email to the Bcc recipient. The originator client also sends the original email to the at least one other recipient.

In the fifth step 130, the Bcc recipient forms a reply email. The reply email is in reply to the original email or another email in an email thread that comprises the original email. The email thread comprises the original email and other emails sent in response to the original email or any other email in the email thread. The Bcc recipient typically forms the reply email on a client of the Bcc recipient, termed the Bcc recipient client. The original email message may be formed, for example, within a window shown in FIG. 5. Because of the third step 222 where the originator client replaced the email addresses of the at least one other recipient with the email address of the originator forming a modified email addresses, the reply email is only addressed to the originator.

In the sixth step 150, the Bcc recipient sends, through the Bcc recipient client, the reply email. The reply email is only sent to the originator.

In the seventh step 160, the reply email goes only to the originator. The originator receives the reply email. The other email recipients do not directly receive the reply email from the Bcc recipient that formed the reply email.

In the eighth step 161, the originator decides whether to forward the reply email to the other recipients, or not to forward the reply email to the other recipients. The originator can selectively decide, that is, the originator can decide to forward the reply email to one or more of the at least one other recipient while not forwarding the reply email to one or more others of the at least one other recipient. The decision can be a real time decision, that is, the originator makes the decision for each reply email and for each of the at least one other recipient. Alternately, the decision can be a premade decision, that is, the originator has instructed the originator client to automatically forward the reply email to all or selected ones of the at least one other recipient, or alternately not to forward the reply email to all or selected ones of the at least one other recipient.

The originator client knows the identity, and therefore the true email addresses of the other recipients, in one of two ways. The first way is the association, within the reply email sent by the Bcc recipient, of the at least one other recipient names with the email address of the originator. The association of at least one other recipient name with the email address of the originator was previously described with reference to FIG. 4. In this case, the names of at least one other recipient were retained within the reply email, but the email addresses associated with the names were changed to the email address of the originator. In the second way, the names of at least one other recipient, in association with the originator address, do not have to be retained within the reply email sent by the Bcc recipient. The originator, or the originator client, knows the names of the other recipients by association with the original email. The originator, or the originator client, identifies the original email using identifying text in the reply email, for example using identifying text within the subject entry block 590 of the reply email, or by using identifying text within the message block 530 of the reply email.

In the ninth and last step 162, the originator forwards reply email to the at least one other recipient in accordance with the decision made the eighth step 161.

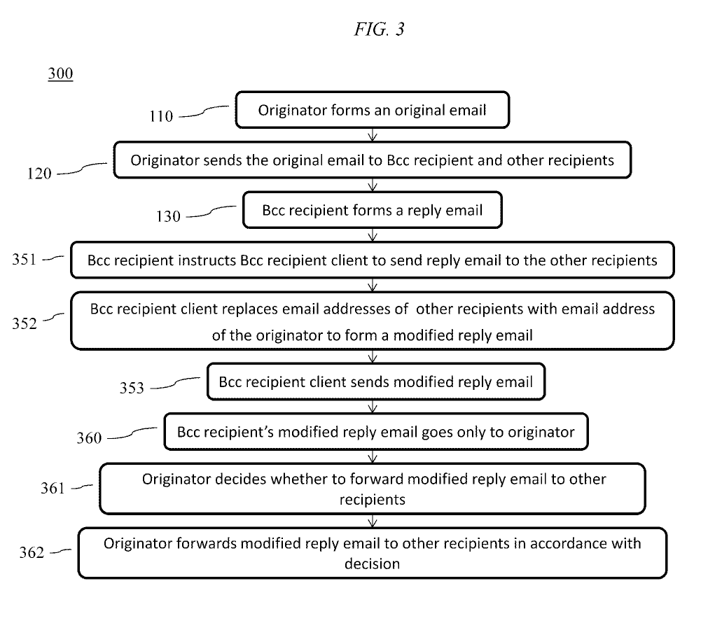

FIG. 3 shows a third method 300 of communication by email according to an embodiment of the invention. The third method 300 allows the Bcc recipient to reply to an email within an email thread without disclosing the identity of the Bcc recipient.

FIG. 3 shows the steps of the third method 300 occurring in an exemplary order. The invention is not so limited; the steps may occur in other orders.

In the first step 110, an originator forms an email original email message. The email message is typically formed on a client of the originator, termed the originator client. Methods of forming an email message are known in the art. For example, the original email message may be formed within a window shown in FIG. 5.

In the second step 120, the originator sends the original email message to at least one Bcc recipient and at least one other recipient. The at least one other recipient is, for example, a To recipient, a Cc recipient, another Bcc recipient, or a combination of To, Cc and other Bcc recipients.

In the third step 130, the Bcc recipient forms a reply email. The reply email is in reply to the original email or another email in an email thread that comprises the original email. The email thread comprises the original email and other emails sent in response to the original email or any other email in the email thread. The Bcc recipient typically forms the reply email on a client of the Bcc recipient, termed the Bcc recipient client. The original email message may be formed, for example, within a window shown in FIG. 5. The reply email is addressed to recipients of the original email, for example, all of the To, Cc and Bcc recipients of the original email. The reply email is also addressed to the originator.

In the fourth step 351, the Bcc recipient instructs the Bcc recipient client to send the reply email to at least one other recipient.

In the fifth step 352, the Bcc recipient client replaces the email addresses of the at least one other recipient with the email address of the originator to form modified email addresses and to form a modified reply email. The reply email is modified to form the modified reply email comprising the modified email addresses in place of the at least one other recipient. The modified email addresses have been formed so that the modified email addresses comprise the email address of the originator, in place of the email addresses of the at least one other recipient, so that the reply email will not be received by the at least one other recipient directly from the Bcc recipient forming the reply email. For example, with reference to FIG. 4, consider an original email, sent by an originator, having the name Sam Jaybird, to two recipients, a Bcc recipient, and a To recipient having the name Ann White and having a To recipient address 420. The Bcc recipient replies to the original email with a reply email that is intended to go to the originator and to the To recipient, Ann White. However, within the reply email, in order to keep secret the identity, or possibly even the existence, of the Bcc recipient, the To recipient address 420 is replaced with the originator address 430, thus forming a modified reply email. Both the local-part 421 and the domain 422 of the To recipient address 420 are removed. Instead, the local-part 421 and the domain 422 of the To recipient address 420 is replaced by a local-part 431 and a domain 432 of an originator address 430, causing the modified reply email to be sent directly to the originator in place of the To recipient, Ann White. The To recipient name 423 may have been displayed in association with the To recipient address 420 prior to replacing the To recipient address 420 with the originator address 430. For example, the To recipient name 423 may have been displayed in association with the To recipient address 420 within the To recipient address blocks 550 of the reply email composer window 500. In one embodiment, the To recipient name 423 continues to be displayed in association with the To recipient address 420 after replacing the To recipient address 420 with the originator address 430. In another embodiment, the To recipient name 423 is displayed in association with the originator address 430 after replacing the To recipient address 420 with the originator address 430. In the modified reply email message received by the originator as a consequence of the originator address 430 replacing To recipient address 420, the To recipient name 423 may be displayed in association with the originator address 430.

In the sixth 353, the Bcc recipient client sends the modified reply email. Because in the fifth step 352, the email addresses of the at least one other recipient, have been replaced by the email address of the originator, the modified reply email is only sent to the originator.

In the seventh step 360, the modified reply email goes only to the originator. The originator receives the modified reply email. The at least one other recipient does not directly receive the modified reply email from the Bcc recipient that formed the reply email.

In the eighth step 361, the originator decides whether to forward the modified reply email to the at least one other recipient, or not to forward the modified reply email to the at least one other recipient. The originator can selectively decide, that is, the originator can decide to forward the modified reply email to one or more of the at least one other recipient while not forwarding the modified reply email to one or more others of the at least one other recipient. The decision can be a real time decision, that is, the originator makes the decision for each modified reply email and for each of the at least one other recipient. Alternately, the decision can be a premade decision, that is, the originator has instructed the originator client to automatically forward the modified reply email to all or selected ones of the at least one other recipient, or alternately not to forward the modified reply email to all or selected ones of the at least one other recipient.

The originator client knows the identity, and therefore the true email addresses of the at least one other recipient, in one of two ways. The first way is the association, within the modified reply email sent by the Bcc recipient, of the at least one other recipient names with the email address of the originator. The association of the at least one other recipient names with the email address of the originator was previously described with reference to FIG. 4. In this case, the names of the at least one other recipient were retained within the modified reply email, but the email addresses associated with the names were changed to the email address of the originator. In the second way, the names of the at least one other recipient, in association with the originator address, do not have to be retained within the modified reply email sent by the Bcc recipient. The originator, or the originator client, knows the names of the at least one other recipient by association with the original email. The originator, or the originator client, identifies the original email using identifying text in the modified reply email, for example using identifying text within the subject entry block 590 of the modified reply email, or by using identifying text within the message block 530 of the modified reply email.

In the ninth and last step 362, the originator forwards modified reply email to the at least one other recipient in accordance with the decision made the eighth step 161.

The first method 100, the second method 200, and the third method 300 prevent the disclosure of the Bcc recipient identity to the at least one other recipient. Furthermore, the first method 100, the second method 200, and the third method 300 may also prevent the existence of the Bcc recipient from being known, for example, when the originator forwards the reply email to the at least one other recipient, it may be forwarded under the authorship of the originator.

Other alternate embodiments of the invention may be used to screen email before it is received by the intended recipients. In this case, the originator, after receiving the reply or modified reply email, may use criteria, for example criteria related to the content or the of the email, in forming the decision on whether to forward the email or not. Furthermore, the originator may modify the contents of the email before forwarding the email.

In yet other alternate embodiments, the originator and the originator address are not an entity forming the original email and the email address of a sender of the original email, respectively. However, the originator address is still the address of the originator or the originator client that will decide whether or not the reply or modified reply email will be forwarded and/or filtered and what filtering will be performed. In these embodiments, what is termed as the reply email is actually the original email or an email sent within an email thread.

In embodiments described above, email may be interpreted the narrow sense indicating use of an email transfer protocol, for example, SMTP or ESMTP. In an additional alternate embodiment, email is understood as electronic mail encompassing additional communications protocols, for example text messaging. In one additional alternate embodiment, text messaging is used. For example, text messaging that uses a short message service communications protocol or a multimedia messaging service protocol.

FIG. 5 illustrates an email composer window 500 according to an embodiment of the invention. The email composer window 500 comprises control and option block 510, message entry block 530, To recipient entry block 550, Cc recipient entry block 560, Bcc recipient entry block 570, subject entry block 590, and send button 595. The control and option block 510 is a standard feature of most email composer windows. It typically comprises buttons to control the email or to select or set options of the email, for example, buttons associated with attachments, save to file, address book, email priority, insert signature, spell check, and fonts. The subject entry block 590 is where the subject of the email is, optionally, entered. The send button 595 is selected to send the email. Selecting the send button 595 is typically performed by clicking on the send button 595.

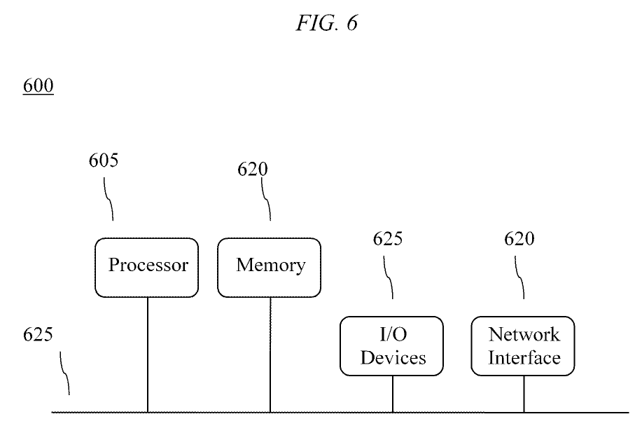

FIG. 6 illustrates a computer system in accordance with which one or more components/steps of the techniques of the invention may be implemented, for example, the components/steps depicted in FIGS. 1-5. It is to be further understood that the individual components may be implemented on one or more such computer system. In the case of an implementation on a distributed computing system, the individual computer systems and/or devices may be connected via a suitable network, e.g., cellular phone network, the Internet, the World Wide Web, a private network, or a local network. The invention is not limited to any particular network.

The computer system shown in FIG. 6 may represent one or more servers, mobile or stationary computing devices, one or more other processing devices, or one or more memory devices capable of providing all or portions of the functions described herein. The computer system may generally include a processor 605, memory 610, input/output (I/O) devices 615, and network interface 620, coupled via a computer bus 625.

It is to be appreciated that the term “processor” as used herein is intended to include any processing device, such as, for example, one that includes a central processing unit (CPU) and/or other processing circuitry. It is also to be understood that the term “processor” may refer to more than one processing device and that various elements associated with a processing device may be shared by other processing devices. Processors may include memory, for example, cache memory.

The term “memory” as used herein includes memory embedded within a processor, an I/O device, and a network interface, for example, a cache memory within a processor. Memory may be embedded within an integrated circuit having other functions, for example, a processor chip with embedded memory. Alternately, memory may be within an integrated circuit functioning mainly as a memory integrated circuit. The term “memory” as used herein is intended to also include memory associated with a processor or CPU, such as, for example, random access memory (RAM), read only memory (ROM), a fixed memory device (e.g., hard disk drive), a removable memory device (e.g., diskette, compact disk, digital video disk or flash memory module), flash memory, non-volatile memory, etc. The memory may be considered a computer readable storage medium. At least one memory contains one or more software programs according to embodiments the invention, for example, one or more software programs formed to implement the first method 100 for communication by email, formed to implement the second method 200 for communication by email, or formed to implement the third method 300 for communication by email according to embodiments of the invention.

In addition, the phrase “input/output devices” or “I/O devices” as used herein is intended to include, for example, one or more input devices (e.g., keyboard, mouse, camera, etc.) for entering data to the processing unit, and/or one or more output devices (e.g., display, etc.) for presenting results associated with the processing unit.

Still further, the phrase “network interface” as used herein is intended to include, for example, one or more transceivers to permit the computer system to communicate with another computer system via an appropriate communications protocol.

Embodiments of the invention illustrate the invention adapted for use with email. The invention is not so limited. Embodiments of the invention are adapted for use with electronic mail, for example test messaging.

Embodiments of the invention illustrate the originator client or the Bcc recipient client replacing the email address of the at least one other recipient with the email address of the originator. In other embodiments, the email address of the at least one other recipient is replaced with the email address of the originator, by other computing resources, for example a server, or an email server to which the originator client or the Bcc recipient client is coupled, for example, coupled by a network.

Illustrated embodiments of the invention are, for example, to keep secret the identity or existence of the Bcc recipient. Alternate embodiments of the invention are intended to keep secret a different recipient, for example, a To or a Cc recipient.

Although illustrative embodiments of the invention have been described herein with reference to the accompanying drawings, it is to be understood that the invention is not limited to those precise embodiments, and that various other changes and modifications may be made therein by one skilled in the art without departing from the scope of the appended claims.

What is claimed is:

1. A method of communication by electronic mail, wherein the method comprises the steps of:
forming an original electronic mail by an originator
replacing a second recipient address, associated with a second recipient, with a third recipient address associated with a third recipient;
sending the original electronic mail to a first recipient; and
forwarding, by the third recipient, a first electronic mail to the second recipient.

2. The method of claim 1 further comprising the steps of:
forming a first electronic mail by the first recipient; and
sending the first electronic mail to the third recipient.

3. The method of claim 1, wherein the step of the forming of the original electronic mail comprises addressing the original electronic mail to the second recipient, wherein the step of the replacing of the second recipient address comprises the sub-steps of:
removing the second recipient address from an address block of the original electronic mail; and
inserting the third recipient address into the address block of the original electronic mail, and wherein a computing resource associated with the originator is adapted to perform the sub-steps of the removing of the second recipient address and the inserting of the third recipient address.

4. The method of claim 2, wherein the step of the forming of the first electronic mail comprises addressing the first electronic mail to the second recipient, wherein the step of the replacing of the second recipient address comprises the sub-steps of:
removing the second recipient address from an address block of the first electronic mail; and
inserting the third recipient address into the address block of the first electronic mail, and wherein a computing resource associated with the first recipient is adapted to perform the sub-steps of the removing of the second recipient address and the inserting of the third recipient address.

5. The method of claim 2, wherein the first electronic mail is sent to the third recipient in place of the second recipient.

6. The method of claim 1, wherein the step of the replacing of the second recipient address comprises removing the second recipient address from at least one of a To address block, a Cc address block, and a Bcc address block, and wherein the step of the inserting of the third recipient address comprises inserting the third recipient address into at least one of the To address block, the Cc address block, and the Bcc address block, and wherein at least one of the original electronic mail and the first electronic mail comprise the at least one of the To address block, the Cc address block, and the Bcc address block.

7. The method of claim 2, wherein the first electronic mail in a reply to the original electronic mail.

8. The method of claim 1, wherein a computing resource of the third recipient is adapted to perform the step of the forwarding of the first electronic mail.

9. The method of claim 1, wherein the second recipient is identified by a second recipient identifier, and wherein the first electronic mail comprises a second recipient identifier.

10. The method of claim 9, wherein the second recipient has a second recipient name, and wherein the second recipient identifier comprises at least one of the second recipient name and text including at least a portion of the second recipient address.

11. The method of claim 1, wherein the third recipient is the originator, wherein the originator has an originator address, and wherein the third recipient address is the originator address.

12. The method of claim 1 wherein the first recipient is a Bcc recipient of the original electronic mail.

13. The method of claim 1, wherein the third recipient modifies the content of the first electronic mail before forwarding the first electronic mail to the second recipient.

14. An article of manufacture for forming a communication by electronic mail, the article comprising a computer readable storage medium having one or more programs embodied therewith, wherein the one or more programs, when executed by a computer, perform steps of:
forming an original electronic mail by an originator
replacing a second recipient address, associated with a second recipient, with a third recipient address associated with a third recipient;
sending the original electronic mail to a first recipient; and
forwarding, by the third recipient, a first electronic mail to the second recipient.

15. The article of manufacture of claim 14, wherein the one or more programs, when executed by the computer, further perform steps of:
forming a first electronic mail by the first recipient; and
sending the first electronic mail to the third recipient.

16. The article of manufacture of claim 14, wherein the step of the forming of the original electronic mail comprises addressing the original electronic mail to the second recipient; wherein the step of the replacing of the second recipient address comprises the sub-steps of:
removing the second recipient address from an address block of the original electronic mail; and
inserting the third recipient address into the address block of the original electronic mail, and wherein a computing resource associated with the originator is adapted to perform the sub-steps of the removing of the second recipient address and the inserting of the third recipient address.

17. The article of manufacture of claim 15, wherein the step of the forming of the first electronic mail comprises addressing the first electronic mail to the second recipient, wherein the step of the replacing of the second recipient address comprises the sub-steps of:
removing the second recipient address from an address block of the first electronic mail; and
inserting the third recipient address into the address block of the first electronic mail, and wherein a computing resource associated with the first recipient is adapted to perform the sub-steps of the removing of the second recipient address and the inserting of the third recipient address

18. Apparatus for forming a communication by electronic mail, the apparatus configured to:
form an original electronic mail by an originator;
replace a second recipient address, associated with a second recipient, with a third recipient address associated with a third recipient;
send the original electronic mail to a first recipient; and
forward, to the second recipient, a reply electronic mail from the first recipient, wherein the originator forwards the reply electronic mail.

19. The apparatus of claim 18, wherein the apparatus comprises:
a memory; and
a processor coupled to the memory.

20. The apparatus of claim 18, the apparatus further configured to:
form the reply electronic mail; and
send the reply electronic mail.
